(19) United States
(12) Patent Application Publication
(10) Pub. No.: US 2002/0147826 A1
(43) Pub. Date: Oct. 10, 2002

(54) Apparatus and method for sending point-to-point protocol over ethernet

(76) Inventor: Daniel Sultan, Paris (FR)

Correspondence Address: Akerman Sentefitt & Eidson PA, 1 S.E. 3rd Avenue, 28th Floor, Miami, FL, 33131, US

(21) Appl. No.: 10/091,171

(22) Filed: Mar. 4, 2002

Related U.S. Application Data
(63) Continuation-in-part of application No. 09/798,432, filed on Mar. 2, 2001.

(51) Int. Cl. G06F 15/16

(52) U.S. Cl. 709/230

(57) ABSTRACT

A method of using point-to-point protocol (PPP) to transmit information from a device connected to an ethernet network, comprises the steps of identifying each packet having a PPPoE header and an encapsulated TCP packet, determining whether the SYN flag within the header of the TCP header is set, and if the SYN flag is set, modifying the value of the Maximum Segment Size in the TCP header to be no larger than 1452 bytes, and transmitting said packet to the destination address appearing in said IP header.

This application is a continuation-in-part of application Ser. No. 09/798,432, filed Mar. 2, 2001, and which is incorporated herein in its entirety by reference.

### FIELD OF THE TECHNOLOGY

This invention relates to computer networks and specifically to a method of transmitting and receiving information using point-to-point protocol (“PPP”) over an ethernet network. Although the use of this invention is not limited to the internet, the internet provides the primary environment for practicing the invention.

### BACKGROUND OF THE INVENTION

The internet is not a single network, but comprises a large number of interconnected networks. When information is to be transmitted across the internet, the device originating the information, which may be a computer, will initially construct packets in which the data being transmitted is contained as a “payload.” “Headers” and “trailers” conforming to the transmission protocols being used will be prepended and appended to the data to provide routers with sufficient information to forward the packets from network to network, in a series of “hops,” until the packet arrives at its intended destination. As used in this specification, “packet” shall refer, generically, to a sequence of bytes representing a unit of data being transmitted pursuant to one or more transmission protocols. “Bytes” shall refer to an octet of binary digits. Once the packet arrives at its destination, headers and footers are stripped away, and the data is made available to the appropriate process running on the recipient computer.

Within the design of IP (“internet protocol”), every physical network has a maximum packet size, designated “maximum transmission unit,” or MTU, and the MTU may be different for different networks. MTU is determined as a function of network design, including network bandwidth, maximal diameter, and desired imposed jitter. Since an IP packet in transit will frequently traverse more than a single network, it may encounter MTUs of different sizes. Since a packet cannot be transmitted over a network whose MTU is smaller than the packet size, one possible solution has been for a sending device to use a path MTU discovery algorithm to determine the smallest MTU that will be encountered during transit to the destination, and to establish a maximum packet size based upon that information. However, that solution has encountered a number of documented difficulties (RFC 2923, “TCP Problems with Path MTU Discovery”), and does not always present an acceptable solution for the problem.

Each network segment is defined by a router, and a packet passing through a router when transiting from one network to another will have its headers and trailers analyzed, stripped, modified, or added to by the router, depending upon the protocol being used by the next network segment. In order to route packets efficiently, routers maintain information about the networks connected to them, including the MTU. When a router encounters a packet that is larger than the MTU for the next network segment in the path to the packet's destination, the packet will not be accepted by the network segment, and may be lost, with a resulting communication failure between the sending and receiving devices. For this reason, it is important that packets be properly sized to be accepted by the networks they will be transiting.

Because each packet of information is discretely routed from source to destination, packets may follow different paths, depending upon network conditions. While most networks comprising the internet are high speed networks, using protocols such as ATM and the like, conditions occasionally arise in which other, slower transmission protocols and media are used. Under some circumstances, passage across a network may involve a packet's being transmitted across an ethernet network using point-to-point protocol (“PPP”). Such protocols may be found in dial-up networks, ISDN, and, more recently, DSL networks, and are frequently used to connect individual devices to an internet service provider. When this combination of protocols is used, it is not uncommon for difficulties to arise that culminate in the loss of transmitted data.

Data to be transmitted to a remote device will normally be generated by a process running on a computer. The data will be sent to a TCP buffer in the RAM of the computer where it will be formatted and encapsulated within a TCP header and an IP header which provide addressing information for the packet and for the process on the recipient machine. Thereafter, additional headers will be added, depending upon the network protocols being used on the network to which the computer is connected. For ethernet networks, the last header to be added will be an ethernet header, which is added by the ethernet driver that is attached to the physical transmission medium. When the packet is received at the destination, a reverse process is employed to decapsulate the packet and provide data to the appropriate process running on the destination computer. The processes of encapsulation and decapsulation, and associated functions of receiving, comparing, setting option and header values, transmitting, and the like, are carried out by programs and drivers running on the sending device.

Ethernet is a low-level network protocol, and is the primary protocol found in local area networks (LANs). Ethernet frames transport data carried in higher level protocols across ethernet networks. Ethernet drivers accept information formatted by upper level protocols such as IP, TCP (transmission control protocol), ARP (address resolution protocol), and ICMP (internet control message protocol), and “encapsulate” it for delivery across the ethernet network.

Ethernet is a multiple access network in which many devices may be attached to the same physical transmission medium. Because each device on an ethernet network must be able to be uniquely distinguished from the others, each is identified by a globally unique physical address, sometimes referred to as a “medium access control”, or “MAC” address. When information is to be delivered across an ethernet network, the sending device adds an eight byte preamble and an ethernet header at the beginning of the packet. The ethernet header is 14 bytes, and comprises the destination device's MAC address, the sending device's MAC address, and the ethernet type. A 4-byte trailer comprising a check frame sequence is appended to the packet. The packet is then transmitted to the network, and the device that recognizes its own address in the destination address field receives the frame.

Ethernet frames may be of varying length. However, the maximum permissible length of an ethernet frame which, by convention, does not include the preamble, but which does include the header (which holds the source and destination addresses, and the ethernet type), and the trailing Frame Check Sequence, is 1518 bytes.

Information formatted in higher level protocols, such as IP, TCP, or PPP, is contained in a data field, or “payload,” that is located between the ethernet frame's header and trailer. Because the maximum size of an ethernet packet is 1518 bytes, including the 14-byte header and the 4-byte trailer, the maximum size payload for an ethernet packet is 1,500 bytes. All information associated with packets from upper layer protocols, including their headers, must fit within the 1500 byte limit of the ethernet payload.

The suite of protocols known as TCP/IP (“Transmission Control Protocol/Internet Protocol”) is the protocol used to carry information over the internet. TCP/IP is also used in many LANs that are, or may be, connected to the internet. The IP portion of TCP/IP is a network layer protocol that supports TCP and other higher layer protocols. IP uses a header that includes the source and destination addresses of the sending and recipient devices in the now-familiar 32-bit format representing four decimal numbers: xxx.xxx.xxx.xxx. The basic IP header is 20 bytes in length, although the addition of options in an “Options” field may extend the length past 20 bytes. Most options for an IP header are used only for diagnostic purposes, and an IP header generally will have a length of 20 bytes except under the most unusual conditions.

TCP is a protocol located above IP, in the transport layer, and a TCP packet will always be encapsulated within an IP packet for transmission to its destination. TCP embodies an architecture having all of the functionality required to implement reliability, sequencing, flow control, and streaming necessary for an end-to-end signaling model. TCP provides a communication channel between processes on each host system by communicating through a “socket,” which is bound to a TCP port address, and which acts as the interface between the process and the network.

The basic TCP header is 20 bytes in length, and relies upon the IP header within which it is encapsulated to provide source and destination device addresses. The TCP header includes source and destination ports, and other information needed to place packets in sequence, to control packet fragmentation, to acknowledge receipt of a packet, to verify the integrity of information, to signal various conditions, and to carry out other functions. The TCP header may also contain options which will control the handling of following TCP packets in the session. One of those options is a maximum segment size (“MSS”) value which occupies 4 bytes of the TCP options field (2 bytes identify the option as MSS and two bytes represent the number of bytes for the maximum segment size). When set, this number limits the number of bytes in the TCP payload that the sending device is prepared to receive throughout the session.

The header of a TCP packet for “opening” a socket for communications will set a flag bit to signal a SYN (synchronize) condition, and will include other information that is used in the session associated with the socket being opened. The MSS value can be set only in the initial SYN packet. Other options, such as the Window Scale option and the SACK (“selective acknowledgment) are also available only in an initial SYN packet. Once the TCP session has been opened, and throughout the session until the session is closed (by setting a bit in the FIN flag) the TCP parameters for communicating with the socket will remain as they were established when the session was opened, and the TCP header will remain at a constant length of 20-bytes throughout the session.

The point-to-point protocol (“PPP”) is a set of interdependent protocols designed to work together to support the concurrent operation of multiple higher-layer protocols over a PPP serial link. PPP is an IETF (Internet Engineering Task Force) Standard specified in RFC-1661. PPP provides a standard for transporting such higher-level protocols between two peer devices by encapsulating higher-level data along with negotiation mechanisms for configuring the link. The PPP header may include configuration options, one of which is a “maximum-receive-unit” (MRU). This option may be sent to inform the peer (receiving device) that the implementation can receive larger packets, or to request that the peer send smaller packets. The default MRU is 1500 bytes.

PPP is probably best known for use in telephone or ISDN dial-up links, or DSL connections between individual computers and internet service providers (“ISPs”) who provide a connection to the internet. Data formatted for IP is encapsulated within a PPP packet for delivery from the individual computer to the ISP. At the ISP, the encapsulation will be stripped away, and the IP packet will be delivered to the internet for further transmission to its destination.

Because PPP was developed as a protocol to connect two “peer” devices, it lends itself to methods of access control, billing functionality, and type of service demands. These features and controls, although desirable under particular circumstances, are specific to “two-party” networks, and are not available in traditional ethernet networks. These desirable features of PPP have led to recent efforts to develop a method for transmitting PPP over ethernet networks. These efforts are described in RFC-2516 which, although not an internet standard, proposes a method for transmitting PPP over Ethernet (“PPPoE”) by encapsulating PPP packets within ethernet packets to provide many of the benefits associated with each of the protocols.

The PPPoE header for an ethernet frame is 6 bytes long. The payload of a PPPoE packet includes a PPP packet, whose header is 2 bytes in length, and any other packets that may be encapsulated within the PPP packet. Optional “tags” attached to the PPPoE packet are carried in the payload section, and may further reduce the maximum PPP payload size. In order to accommodate the PPP packet within the ethernet frame, RFC 2516 provides that the MRU option must not be negotiated to be larger than 1492 bytes. This options is relevant, however, only when the PPP packet will be received by the device that will generate a responding transmission. However, when the packet that is encapsulated within the PPP packet is destined for a device that lies beyond the network segment that is using PPP, the PPP and PPPoE headers will be stripped from the packet before it reaches its destination, and the packet will then be routed to its final destination without the MRU information. When this happens, the receiving machine will not be aware that the packet it sends in response will be transiting a network segment using PPP protocol on its trip back to the sending device, and it will default to sending a packet whose size is limited to the maximum size for an ethernet payload, or 1500 bytes.

When this responding packet reaches the router immediately preceding the PPPoE segment, the addition of the PPP (2 byte) and PPPoE (6 byte) headers may increase the size of the ethernet payload to more than 1500 bytes, if the payload's original size had been larger than 1492 bytes. When that happens, the packet will be larger than the MTU for that network, will not be able to transit the network segment, and will be lost.

The method and apparatus of the present invention uses the initializing TCP header to carry information to the receiving machine to limit the size of TCP packets transmitted from the receiving device to the sending device. This ensures that packets sent by the receiving device will be at least 8 bytes smaller than the maximum packet size for ethernet, and will permit those packets to accept PPP and PPPoE headers without becoming larger than the maximum packet size for ethernet.

### SUMMARY OF THE INVENTION

This invention allows for adjustment of the packet size by adjusting the maximum segment size (“MSS”) in the encapsulated TCP packet that opens a session using a SYN command. The TCP MSS option is located in the TCP header, and specifies the maximum number of data octets (defined herein as “bytes”) in a TCP segment exclusive of the TCP header (RFC 879). In the preferred embodiment of this invention, an MSS of 1452 bytes has been found to provide successful communications, although a packet size of less than 1452 would also be usable, albeit with somewhat lower efficiency.

This is accomplished by identifying TCP SYN packets and setting the value of the MSS in the option section of the TCP header to 1452 bytes. By limiting the MSS to no more than 1452 bytes, the sending device ensures that packets sent by the receiving device will be able to have the PPP and PPPoE headers added, and still be no larger than the ethernet maximum of 1518 bytes.

### BRIEF DESCRIPTION OF THE DRAWINGS

FIG. 1 is a representation of three network segments having routers between network segments and a computer at either end. The makeup of a hypothetical packet is shown at various stages during transit between the computers.

FIG. 2 is a depiction of an ethernet packet in which is encapsulated, respectively, a PPPoE packet, a PPP packet, an IP packet, and a TCP packet having an options field. A byte scale indicating byte length is located at the top of the figure.

FIG. 3 depicts an ethernet packet in which is encapsulated a PPPoE packet, a PPP packet, an IP packet, and a TCP packet in which the options field is absent. A byte scale indicating byte length is located at the top of the figure.

### DESCRIPTION OF THE PREFERRED EMBODIMENT

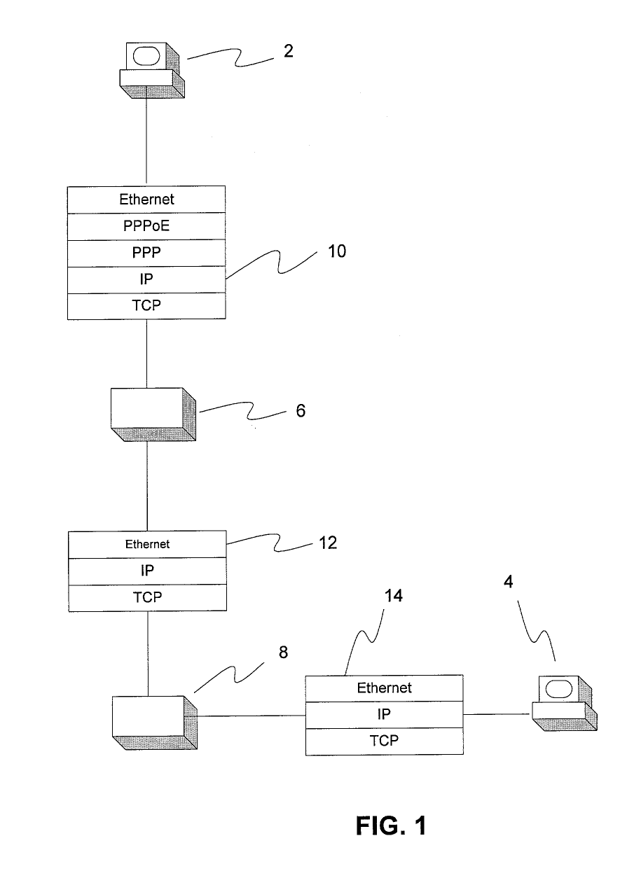

FIG. 1 depicts a hypothetical network having three network segments. A first computer 2 is located at one end, while a second computer 4 is located at the other end. The three network segments are connected by routers 6 and 8. Depictions of a single packet of information are shown at each network segment. When the packet is sent from the first computer 2, it is traversing a network segment that uses point-to-point protocol over ethernet. This may typically be a DSL connection from a home or office to an internet service provider. The packet 10 has a TCP packet that is encapsulated within an IP packet which, in turn, is encapsulated within a PPP packet. The PPP packet is encapsulated within a PPPoE packet, which itself is encapsulated within an ethernet packet. In accordance with the present invention, as the packet left the sending computer 2, the MSS option field value was set at “1452” bytes. In addition, the MRU option of the PPP packet would have been set at 1492. If the PPP were being used on a serial network having only two devices, the receiving device would be able to use the MRU to send responding packets of the requested size. In FIG. 1, however, the packet 10 will be received at router 6, and will be routed to router 8 on an ethernet segment that does not use PPP. Router 6 will therefore strip out the PPP and the PPPoE headers from the packet 12, will place the proper source and destination MAC addresses for sending to router 8 in the address field of the ethernet header, and will recalculate the check sum before sending the packet to router 8. When the packet arrives at router 8, it will again have the correct source and destination MAC addresses placed in the ethernet header, recalculate the check sum, and will transmit the packet 14 to the second computer 4. When the second computer prepares to send a responding message, it will obtain packet size information from the MSS field option in the TCP packet. In so doing, it will limit packet size to at least 8 bytes less than the maximum for ethernet transmissions, thereby assuring that there will be room in the packet for the PPP and PPPoE headers when the packet reaches router 6 for delivery across the ethernet segment using PPP to first computer 2.

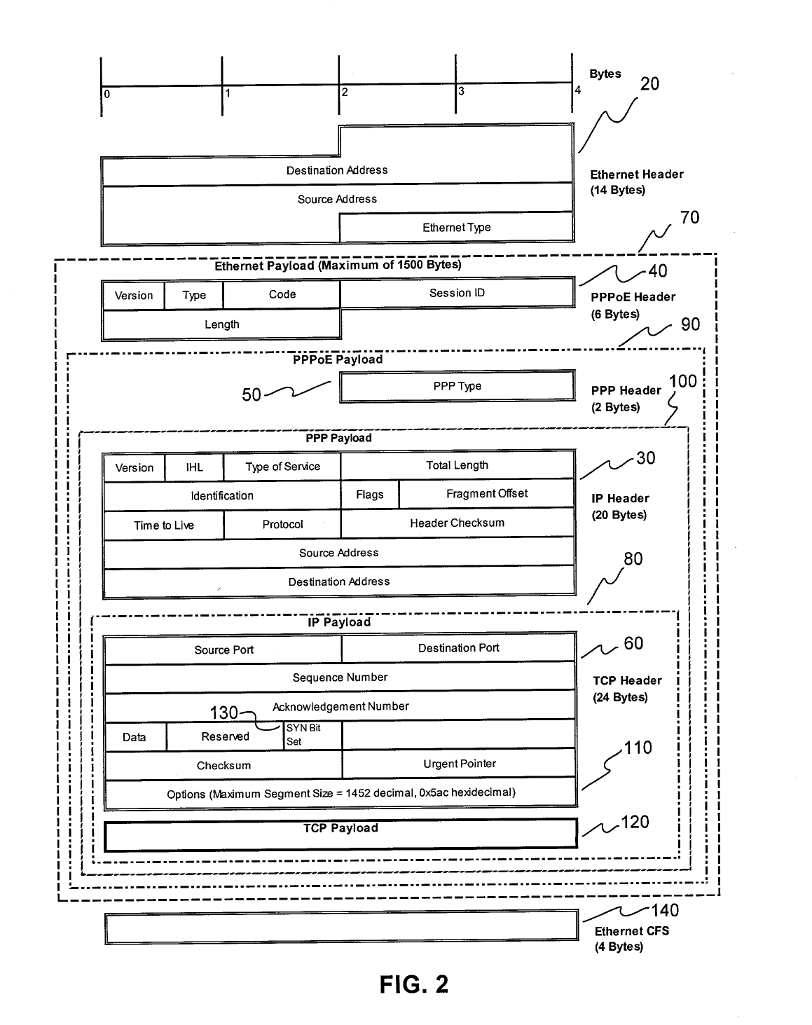

In FIG. 2, an ethernet packet is depicted 10 in which is encapsulated, respectively, a PPPoE packet 70, a PPP packet 90, an IP packet 100, and a TCP packet 80. Each packet has a header and a payload associated with it. The ethernet packet header 20 has a length of 14 bytes. The payload for the ethernet packet 70 includes the entirety of the PPPoE packet. The header 40 for the PPPoE packet occupies 6 bytes, and has a payload 90 that encompasses the PPP packet. The PPP header 50 is a 2-byte header having as the PPP payload the entire IP packet 100. The standard header 30 for the IP packet has a length of 20 bytes, not including optional fields which are not present in FIG. 2. The payload 80 for the IP packet includes the entirety of the TCP packet. The TCP header 60 includes an options field 110 which can hold information for the maximum segment size (“MSS”). As depicted in FIG. 2, the TCP header 60 with the optional 4 byte MSS is 24-bytes in length. In this packet the SYN flag 130 would be set, indicating that a session is being initiated and a socket is being opened for interprocess communications. The TCP packet has a payload 120 whose maximum size is determined by the MSS value in the TCP options field 110. The TCP payload 120 carries process-specific information from a socket in the sending device to a corresponding socket in the receiving device. A 4-byte trailing frame check sequence (FCS) 140 is appended to the ethernet packet.

The MSS is a 16 bit number that theoretically may be as large as 65,535. However, because the maximum size for an ethernet payload (not including the ethernet header or trailer) is 1500 bytes, it is clear that any packet in which the size of the ethernet packet, including both the 14 byte header and the 4 byte file check sequence, exceeds 1518 bytes cannot be transmitted over an ethernet medium.

In order to limit ethernet packet length when using PPP, the preferred embodiment of this invention initializes a TCP session by substituting the number “1452” (0x05ac in hexadecimal) into the MSS field when the SYN flag 130 is set in the TCP header. This is shown in FIG. 2 at 110. The value of 1452 is determined by subtracting from the maximum payload value for an ethernet frame (1500 bytes) the number of bytes in the headers of the encapsulated packets. These are, the PPPoE header (6 bytes), the PPP header (2 bytes), the IP header (20 bytes) and the TCP header (20 bytes).

Within a TCP header, the MSS field is one of the options that must be included in a TCP packet to open a socket for a session. Any such TCP socket opening packet may be identified by the SYN flag 130 in the header, which is set for socket opening frames and otherwise is clear. None of the optional fields, including the MSS, the window scale option or the SACK options, will be needed for later transmissions once the session has started.

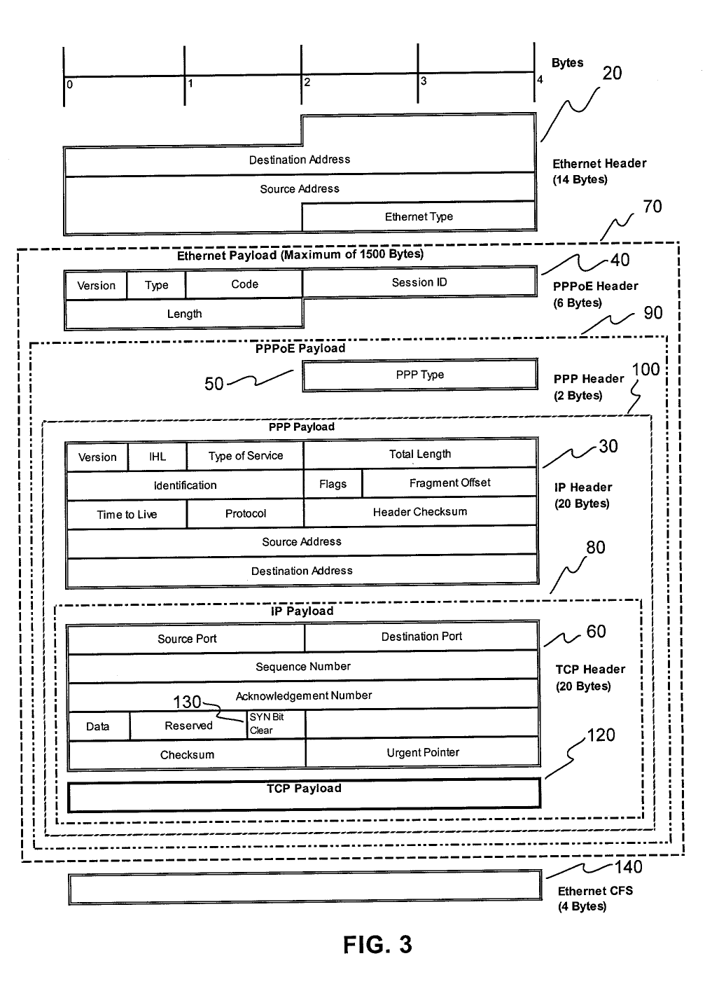

FIG. 3 shows an ethernet packet in which PPP is encapsulated, and the TCP header does not include an options field. Because this packet does not open a session, the SYN flag 130 in the TCP header is clear. For non-initializing TCP packets, the TCP payload will always be preceded by the basic 20 byte TCP header.

The method of this invention can be implemented through software or firmware in any PPPoE session. Implementation may take the form of checking the MSS value for any TCP SYN packet and replacing any MSS value with “1452” if the original MSS value is larger than 1452; or the method could simply write the number “1452” into the MSS field for each TCP SYN packet, without first analyzing the existing value.

Although the preferred embodiment substitutes the value “1452” into the MSS option for initializing TCP packets, those of skill in the art will appreciate that any other number that is less than 1452 may be substituted into the MSS field, and will ensure that the receiving device will send responding packets that are more than 8 bytes smaller than the maximum size for an ethernet packet. Other network factors may indicate the use of a smaller packet size, although a smaller packet size may require more packets to be transmitted to convey the same data, resulting in a decrease in communications efficiency. It will be understood that the description herein relates to the preferred embodiment of the invention, and that the scope of the invention will encompass a range of MSS values, and is limited only by the following claims.

What is claimed is:

1. A method for transmitting data across a network having an ethernet network segment using point-to-point protocol (PPP), comprising the steps of:
identifying each packet having a TCP packet encapsulated within a PPPoE packet that is to be transmitted across said network;
analyzing each said identified TCP packet to determine whether the SYN flag within the header of said TCP packet is set;
if said SYN flag is set, comparing the MSS value contained in said TCP header with a predetermined decimal number that is no larger than the decimal number 1452,
if said MSS value is larger than said predetermined decimal number, substituting the predetermined decimal number into said MSS value;
transmitting said packet to said network for routing to a destination.

2. A method for transmitting data across an ethernet network segment using point-to-point protocol as claimed in claim 1, wherein said predetermined decimal number is 1452.

3. A method for transmitting data from a first device to a second device across a network having an ethernet network segment using point-to-point protocol, comprising the steps of:
identifying packets transmitted from said first device having a TCP packet encapsulated within an ethernet header;
for each identified TCP packet, determining whether the header of said TCP packet contains an MSS field;
determining whether the value in said MSS field is larger than the decimal number 1452;
if said value in said MSS field is larger than the decimal number 1452, substituting a predetermined number no greater than the decimal number 1452 into said MSS field,
placing said packet on said network for delivery to said second device.

4. A method for transmitting data from a first device to a second device across a network having an ethernet network segment using point-to-point protocol as claimed in claim 3, wherein said predetermined number is the decimal number 1452.

5. A method for transmitting data from a first device to a second device across a network having an ethernet network segment using point-to-point protocol, comprising the steps of:
identifying packets transmitted from said first device having a TCP packet encapsulated within an ethernet header;
for each identified TCP packet, determining whether the header of said TCP packet contains an MSS field;
for each identified TCP packet containing an MSS field, substituting a predetermined number no greater than the decimal number 1452 into said MSS field,
placing said packet on said network for delivery to said second device.

6. A method for transmitting data from a first device to a second device across a network having an ethernet network segment using point-to-point protocol as claimed in claim 5, wherein said predetermined number is the decimal number 1452.

7. A machine readable storage having stored thereon a computer program for transmitting information over an ethernet network using point-to-point protocol (PPP), said computer program comprising a routine set of instruction for causing the machine to perform the steps of:
accepting a packet for transmission across said ethernet network;
determining whether said packet contains an encapsulated TCP packet having a header option for an MSS field;
comparing the value in said MSS field with the decimal number 1452;
for packets having an MSS value greater than the decimal number 1452, substituting a predetermined number no greater than the decimal number 1452 into said MSS field,
placing said packet on said network for delivery to said second device.

8. A machine readable storage having stored thereon a computer program for transmitting information over an ethernet network using the point-to-point protocol, said computer comprising:
a TCP packet buffer
a comparator configured to determine whether a header of a TCP formatted packet in said TCP packet buffer contains an MSS field;
an MSS setter configured to set said MSS field to a value in a range from zero to 1452;
an encapsulator configured to encapsulate said TCP-formatted packet within a payload of an IP packet, to encapsulate said IP packet within a payload of a PPP packet, to encapsulate said PPP packet within a payload of a PPPoE packet, and to encapsulate said PPPoE packet within a payload of an ethernet packet; and
an ethernet packet transmitter.

9. A machine readable storage as claimed in claim 8 wherein said MSS setter is configured to set said MSS field to a value of 1452.
